(19) United States
(12) Patent Application Publication
(10) Pub. No.: US 2005/0032576 A1
(43) Pub. Date: Feb. 10, 2005

(54) Resolution adjustable game controller

(76) Inventors: Chiu Hao Cheng, Miao Li Hsien (TW); Ming Kuo Cheng, Taichung Hsien (TW)

Correspondence Address: CHIU HAO CHENG, 235 P.O. BOX 10-69, CHUNG-HO, TAIPEI, TW

(21) Appl. No.: 10/780,227

(22) Filed: Feb. 18, 2004

(30) Foreign Application Priority Data
Feb. 18, 2003 (TW) 092202541

(51) Int. Cl. A63F 13/00

(52) U.S. Cl. 463/37

(57) ABSTRACT

A resolution adjustable game controller has a resolution button and a linear controller. When the resolution button is pushed, the resolution of the linear controller is changed to another resolution, and when the resolution button is released, the resolution restores. The resolution button is one of the buttons originally on the game controller or an additional button different from the original buttons on the game controller. The control circuit is a chip which is electrically connected to the resolution button for controlling the resolution. When the resolution button is pushed, the resolution button is triggered, when the resolution button is released, the trigger condition is also released.

### FIELD OF THE INVENTION

The present invention relates to game machines, and particular to a resolution adjustable game controller of a game machine having a resolution button and a linear controller, wherein a resolution button is used, which can be the original button of the game machine or an additional button. When the resolution button is pushed, the resolution of the linear controller is changed to another resolution, and when the resolution button is released, the resolution restores.

### BACKGROUND OF THE INVENTION

In the prior art, it is necessary to control the resolution of a game machine for performing some precise actions. In the hardware of a game machine, the resolution thereof is controlled by a linear controller. If some precise actions are necessary, several actions are necessary for adjusting the resolution of the game machine.

For example, if a minor object is generated in a frame of a game, it is necessary to adjust the resolution to a finer one so that the cursor can accurately click the object. If the resolution is too larger to be adjusted one time, then several times are necessary to adjust the resolution to a desire one for controlling precisely.

For example, in a racing car game, if a car is driven in a curved path and a linear controller is used to control the direction of the car so that the car can drive smoothly through the path without moving out of the path, when the resolution is too large, the user can not precisely control the car position so that the car can be confined in the path. Thereby, it is necessary to adjust the resolution of the frame so that the car position can be fine-adjusted to be confined in the path. This will cause that the user cannot play the game conveniently.

For example, in a flying game, if an object plane appears, it is necessary to the control the linear controller or a joystick to aim the object precisely. If the resolution of the linear controller or the joystick is too large, the aiming action cannot be performed one time. Thereby, the resolution must be adjusted several times. However, this operation will cause the gamer cannot play the game smoothly.

With reference to FIG. 1, the prior art game control 1 is illustrated. The game controller cannot adjust the resolution of the linear controller 11. Thereby, the resolution of the game machine is uncontrollable. Thus, the resolution of the frame cannot be changed so that fine adjustment of the object in the frame cannot be performed.

With reference to FIG. 2, a prior art racing car-used controller is illustrated. The racing car-used controller 2 has a resolution switch 21 for adjusting the resolution. In operating the racing car-used controller 2, two hands are necessary, one for controlling a braking button, and the other for controlling a directional button 22. When the user needs to adjust the resolution of the frame in gaming, one hand must move to the resolution switch 21 so that the user cannot keep his (or her) attention on other operation. Another defect is that an additional resolution switch 21 will increase the cost. Thereby, there is an eager demand for a novel design which retains the number of the buttons of the game controller, the directional controller or the joystick without increasing the cost, but the resolution can be increased. Thereby, to avoid above disadvantages is the object of the present invention.

### SUMMARY OF THE INVENTION

Accordingly, the primary object of the present invention is to provide a resolution adjustable game controller having a resolution button and a linear controller, wherein when the resolution button is pushed, the resolution of the linear controller is changed to another resolution, and when the resolution button is released, the resolution restores. The resolution button is one of the buttons originally on the game controller or an additional button different from the original buttons on the game controller. The control circuit is a chip which is electrically connected to the resolution button for controlling the resolution. When the resolution button is pushed, the resolution button is triggered, when the resolution button is released, the trigger condition is also released.

The various objects and advantages of the present invention will be more readily understood from the following detailed description when read in conjunction with the appended drawing.

### BRIEF DESCRIPTION OF THE DRAWINGS

FIG. 1 is a schematic view of a prior art game controller.

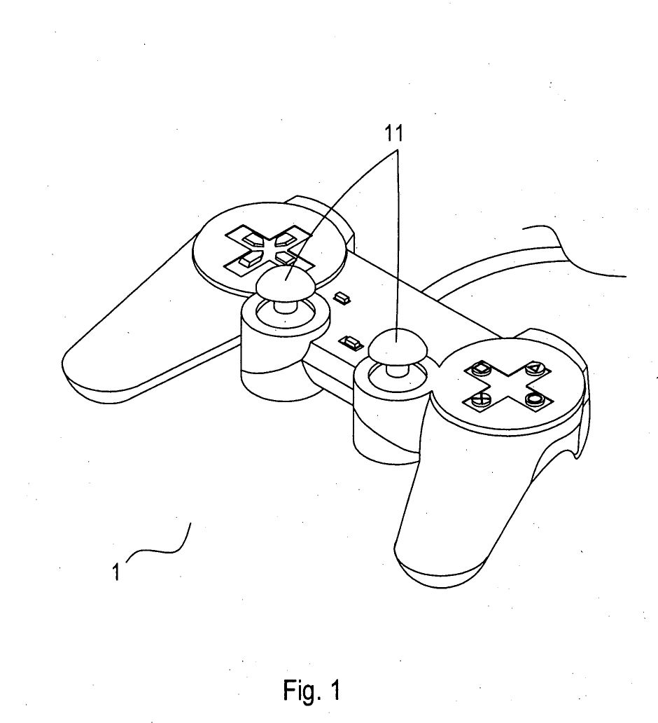

FIG. 2 is a schematic view showing the prior art racing car-used controller.

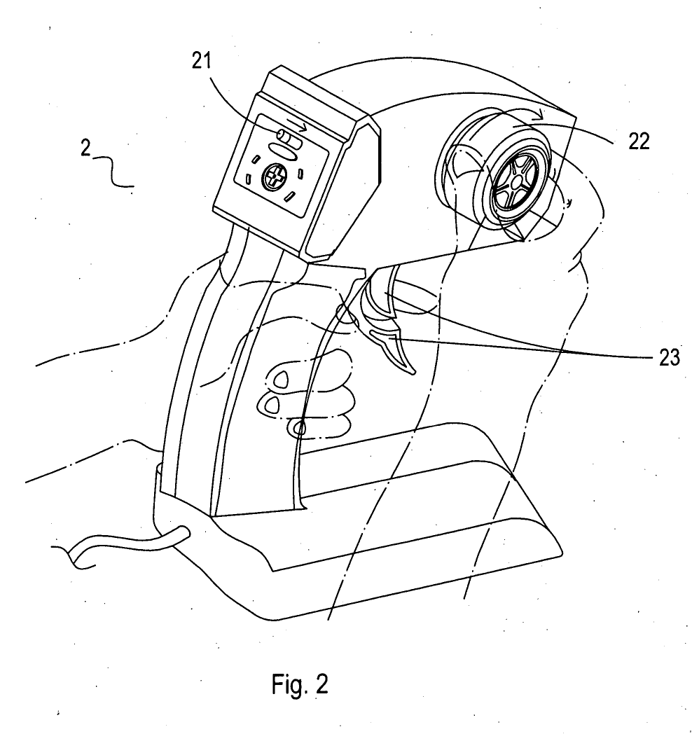

FIG. 3 is an electric block diagram of the resolution adjustable game controller of the present invention.

FIG. 4 is a circuit diagram of the resolution adjustable game controller of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

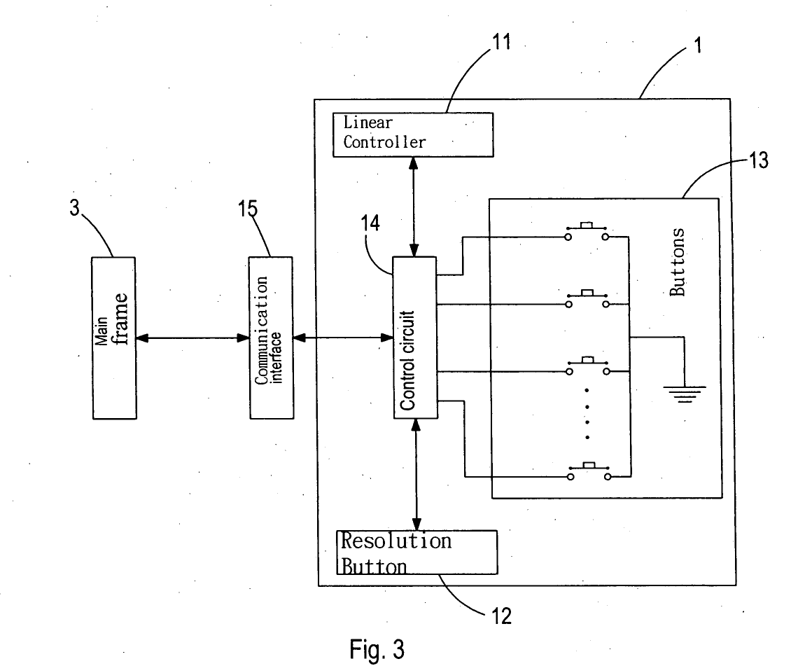

Referring to FIG. 3, the circuit block diagram about one embodiment of the resolution adjustable game controller of the present invention is illustrated. One of the original buttons 13 on the game controller 1 is selected as a resolution button 12 which is electrically connected to a control circuit 14. The control circuit 14 is electrically connected to a linear controller 11. The control circuit 14 is a chip for accepting trigger signals from the plurality of buttons 13. When the resolution button 12 is pushed, the control circuit 14 will output a resolutions value. The resolution value is outputted to a main frame 3 through a communication interface 15 so as to change the resolution of the linear controller 11 of the game controller 1. Further, if the resolution button 12 is released, the resolution of the linear controller 11 of the game controller 1 is restored.

Moreover, in the present invention, the resolution button 12 is different from the original buttons 13. The resolution button 12 is additionally added to the control circuit 14 and placed near the original button 13. As the resolution button 12 is pushed, another resolution is set to the linear controller 11 of the game controller 1. As the resolution button 12 is released, the resolution is returned to the original value.

The control circuit 14 is a chip and is a main core of the circuit for controlling the electric connection of the control circuit 14 and the resolution button 12 so as to control and adjust the resolution to be another value. Since the resolution button 12 is one of the original buttons 13 or located near original buttons 13. Thereby, the above said defects in the prior art can be improved (that is, in the racing car-used controller 2, the resolution switch 21 and directional button 22 are separated so that the control action can not be performed simultaneously).

In the present invention, the trigger operation of the resolution button 12 is performed by pushing the resolution button 12 continuously so that the user can precisely control the game machine. No delay occurs. Moreover, the cost is low.

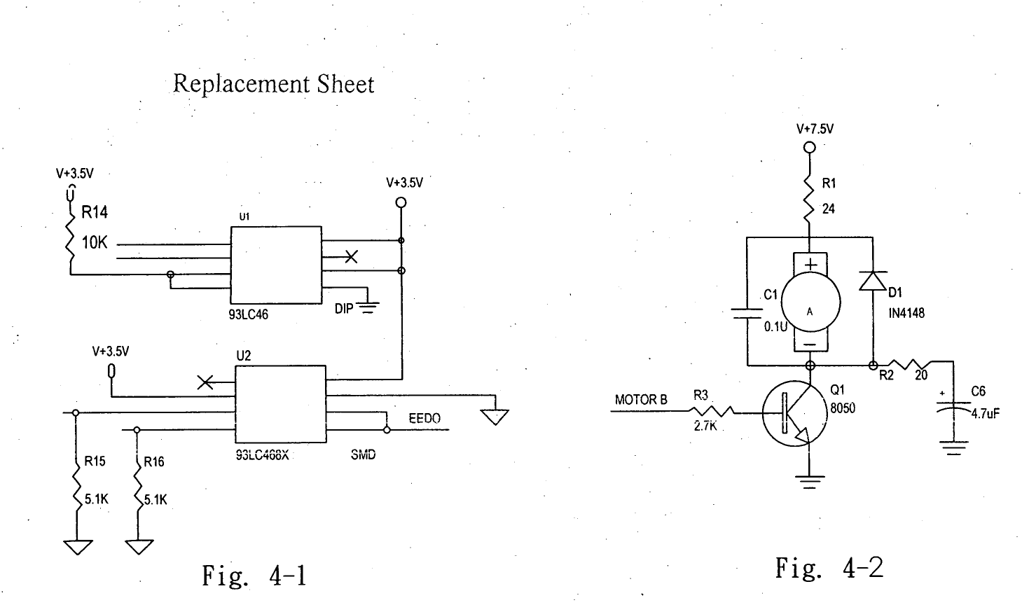

With reference to FIGS. 3 and 4, a circuit about the resolution adjustable game controller of the present invention is illustrated. In the circuit, the control circuit 14 is a microprocessor chip JCH089XX which is a commonly used program controller. The controller can receive the signals from the plurality of original buttons 13. According to this embodiment, the control circuit 14 can receive trigger signals from the resolution button 12 so as to change the resolution of the linear controller 11 to another value. The resolution is outputted to the main frame 3 through the communication interface 15. The communication interface 15 is a PS CON for communicating the game controller 1 with the main frame 3. In this embodiment, two linear controllers 11 are equipped and a plurality of original buttons 13. One of the linear controllers 11 is controlled by the resolution button 12. In another embodiment, the resolution button 12 is added to the control circuit 14, which has the same function as above mentioned.

Advantages of the present invention are that the operation of resolution change and other operation can be performed simultaneously. The precise operation can be performed as desired without any delay. the present invention can be operated conveniently and made with a lower cost.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A resolution adjustable game controller having a resolution button and a linear controller, wherein when the resolution button is pushed, the resolution of the linear controller is changed to another resolution, and when the resolution button is released, the resolution restores.

2. The resolution adjustable game controller as claimed in claim 1, wherein the resolution button is one of the buttons originally on the game controller.

3. The resolution adjustable game controller as claimed in claim 1, wherein the resolution button is an additional button different from the original buttons on the game controller.

4. The resolution adjustable game controller as claimed in claim 1, wherein a control circuit of the game controller is a chip which is electrically connected to the resolution button for controlling the resolution.

5. The resolution adjustable game controller as claimed in claim 1, wherein when the resolution button is pushed, the resolution button is triggered, when the resolution button is released, the trigger condition is also released.
